(19) United States
(12) Patent Application Publication
(10) Pub. No.: US 2013/0275439 A1
(43) Pub. Date: Oct. 17, 2013

(54) SYSTEM AND METHOD FOR MONITORING NUTRITIONAL SUBSTANCES TO INDICATE ADULTERATION

(71) Applicant: Eugenio Minvielle, Rye, NY (US)

(72) Inventor: Eugenio Minvielle, Rye, NY (US)

(21) Appl. No.: 13/887,150

(22) Filed: May 3, 2013

Related U.S. Application Data
(63) Continuation-in-part of application No. 13/771,004, filed on Feb. 19, 2013.
Application No. 13/771,004 is a continuation-in-part of application No. 13/485,883, filed on May 31, 2012.
(60) Provisional application No. 61/624,934, filed on Apr. 16, 2012.
(60) Provisional application No. 61/624,925, filed on Apr. 16, 2012.
(60) Provisional application No. 61/624,915, filed on Apr. 16, 2012.

(51) Int. Cl. G06F 17/30

(52) U.S. Cl. CPC G06F 17/30663
USPC 707/748

(57) ABSTRACT

An information system for nutritional substances obtains information regarding a nutritional substance from the creation of the nutritional substance, the preservation of the nutritional substance, the transformation of the nutritional substance, the conditioning of the nutritional substance, and the consumption of the nutritional substances. The information system stores and provides this information to the various constituents of the nutritional substance supply system. Of particular interest is adulteration with horsemeat, and provisions are described for determining, monitoring and alerting based on detection of such adulteration.

### RELATED PATENT APPLICATIONS

This application is a continuation-in-part of U.S. patent application Ser. No. 13/771,004, filed Feb. 19, 2013, which is a continuation-in-part of U.S. patent application Ser. No. 13/485,883, filed May 31, 2012 and this application further claims the benefit of U.S. patent application Ser. No. 13/646,632, filed Oct. 5, 2012, which is a continuation of U.S. patent application Ser. No. 13/485,883, filed May 31, 2012, which all claim priority to U.S. Provisional Application No. 61/624,915, filed Apr. 16, 2012, U.S. Provisional Application No. 61/624,925, filed Apr. 16, 2012, and U.S. Provisional Application No. 61/624,934, filed Apr. 16, 2012 and this application claims the benefit of priority to International Application No. PCT/US2013/029686, filed Mar. 7, 2013, which claims priority to U.S. Provisional Application No. 61/608,496, filed Mar. 8, 2012, each of which is hereby incorporated by reference herein in its entirety.

### FIELD OF THE INVENTION

The invention relates to an information system for collecting, transmitting and acting upon information during the harvesting, preserving, transforming, conditioning and/or consumption of nutritional substance, and in particular, relates to detection of dynamic evolution, change, residual value and adulteration of nutritional substances.

### BACKGROUND OF THE INVENTION

Nutritional substances are traditionally grown (plants), raised (animals) or synthesized (synthetic compounds and medicaments). Additionally, nutritional substances can be found in a wild, non-cultivated form, which can be caught or collected. While the collectors and creators of nutritional substances generally obtain and/or generate information about the source, history, caloric content and/or nutritional content of their products, they generally do not pass such information along to the users of their products. One reason is the nutritional substance industries have tended to act like “silo” industries. Each group in the food and beverage industry—growers, packagers, processors, distributors, retailers, and preparers work separately, and either shares no information, or very little information, with others. There is generally no consumer access to, and little traceability of, information regarding the creation and/or origin, preservation, processing, preparation, or consumption of nutritional substances. In particular, there is very little or no information available to a consumer, at the moment the consumer wants to know, regarding changes (typically degradation/erosion) in nutritional, organoleptic, or aesthetic values of nutritional substances or regarding residual nutritional, organoleptic, or aesthetic values of the nutritional substance. Further, there is no information available to the consumer regarding changes in nutritional, organoleptic, or aesthetic values of nutritional substances or regarding residual nutritional, organoleptic, or aesthetic values of the nutritional substance after they have been conditioned, and no way for the consumer to know what conditioning protocol will achieve the nutritional, organoleptic, or aesthetic values he desires. It would be desirable for such information to be available to the consumers of nutritional substances at any desired moment, as well as all participants in the food and beverage industry—the nutritional substance supply system. Further, it would be of great benefit for the consumers and other participants to have the ability to share information with desired entities outside the nutritional substance supply system regarding nutritional substances they are considering for use or consumption. For example, a consumer may wish to share such nutritional substance information with their physician in order for the physician to better diagnose and also leverage this information to treat him. The consumer could share such nutritional substance information with a health and fitness organization or website in which he is a member in order to verify if a particular nutritional substance meets his specific dietary needs. The consumer may share such information by granting access to a database with his specific nutritional substance consumption data or might query the desired entity regarding the suitability of nutritional substances being considered for purchase or consumption.

While there has recently been greater attention by consumer organizations, health organizations and the public to the nutritional content of foods and beverages, the food and beverage industry has been slow in responding to this attention. Today's innovation, research and scientific advances of the food and beverage industry have been primarily focused on producing more volume and preserving nutritional substances longer. Moreover, the industry has developed in silos, increasingly adding dyes, preservatives, artificial flavors, enhancers, artificial sweeteners, pesticides, hormones, antibiotics, and other additives to fulfill its various functions.

One reason for this may be that since the food and beverage industry operates as silos, for example of those who create nutritional substances, those who preserve and transport nutritional substances, those who transform nutritional substances, and those who finally prepare the nutritional substances for consumption by the consumer, there has been no system-wide coordination or management of nutritional content. While each of these silo industries may be able to maintain or increase the nutritional content of the foods and beverages they handle, each silo industry has only limited information and control of the nutritional substances they receive, and the nutritional substances they pass along. An interactive system and data base, including user-friendly dynamic nutritional substance labeling allowing consumers, and any other member or other member of the nutritional substance supply system, to access creation and origin information for nutritional substances as well as information regarding changes in nutritional, organoleptic, or aesthetic values of nutritional substances, at any moment during the life-cycle of the nutritional substance up to the moment of consumption, would offer great value to the nutritional substance supply system.

Of particular importance are the measurement, estimation, and tracking of changes to the nutritional content, also referred to herein as ΔN, of a nutritional substance from creation to consumption. This ΔN information could be used, not only by the consumer in selecting particular nutritional substances to consume, but by the other food and beverage industry silos to make decisions on how to create, handle and process nutritional substances. Additionally, those who sell nutritional substances to consumers, such as restaurants and grocery stores, could communicate perceived qualitative values of the nutritional substance in their efforts to market and position their nutritional substance products. Further, a determinant of price of the nutritional substance could be particular nutritional, organoleptic, or aesthetic values, and if changes to those values, also referred to herein as ΔN, are perceived as desirable. For example, if a desirable value has been maintained, improved, or minimally degraded, it could be marketed as a premium product and command a premium price.

For example, the grower of sweet corn generally only provides basic information as the variety and grade of its corn to the packager, who preserves and ships the corn to a producer for use in a ready-to-eat dinner. The packager may only tell the producer that the corn has been frozen as loose kernels of sweet corn. The producer may only provide the consumer with rudimentary instructions how to cook the dinner, and only tell the consumer that the dinner contains whole kernel corn among the various items in the dinner. Finally, the consumer of the dinner will likely not express opinions on the quality of the dinner, unless it was an especially bad experience, in which case the consumer might contact the producer's customer support program to complain. Very minimal, or no, information on the nutritional content of the ready-to-eat dinner is passed along to the consumer. The consumer knows essentially nothing about changes (generally a degradation, but could be a maintenance or even an improvement) to the nutritional content, ΔN, of the sweet corn from creation, processing, packaging, cooking, preservation, preparation by consumer, and finally consumption by the consumer. Unfortunately, today consumers have no way to access information regarding the extent to which nutritional substances have degraded at any moment during their life-cycle, including no information regarding how a nutritional substance will degrade during conditioning. The consumer is even more unlikely to be aware of possible changes to labeling content that a creator, preserver, transformer, or conditioner may just have become aware of, such as changes in information about nutritional, organoleptic, or aesthetic values of the nutritional substance or changes in information regarding the source, creation and other origin information about the nutritional substance. If communicated, such changes or updates to labeling content could affect a purchasing preference or consumption preference of a consumer. Further, if communicated, such changes could affect the health, safety, and wellbeing of the consumer. It is also understood that such changes would best be communicated rapidly and by means readily utilized by a consumer to retrieve such changes or updates. Further, they have no way to access information regarding how to condition a nutritional substance in order to achieve desired nutritional, organoleptic, or aesthetic values. An interactive system and data base including user friendly dynamic nutritional substance labeling allowing consumers to access such information for nutritional substances would offer great value to the nutritional substance supply system.

The caloric and nutritional content information for a prepared food that is provided to the consumer is often minimal. For example, when sugar is listed in the ingredient list, the consumer may not receive any information about the source of the sugar, which can come from a variety of plants, such as sugarcane, beets, or corn, which will affect its nutritional content. Conversely, some nutritional information that is provided to consumers is so detailed, the consumer can do little with it.

If fact, each silo in the food and beverage industry already creates and tracks some information, including caloric and nutritional information, about their product internally. For example, the farmer who grew the corn knows the variety of the seed, condition of the soil, the source of the water, the fertilizers and pesticides used, and can measure the caloric and nutritional content at creation. The packager of the corn knows when it was picked, how it was transported to the packaging plant, how the corn was preserved and packaged before being sent to the ready-to-eat dinner producer, when it was delivered to the producer, and what degradation to caloric and nutritional content has occurred. The producer knows the source of each element of the ready-to-eat dinner, how it was processed, including the recipe followed, and how it was preserved and packaged for the consumer. Not only does such a producer know what degradation to caloric and nutritional content occurred, the producer can modify its processing and post-processing preservation to minimally affect nutritional content. The preparation of the nutritional substance for consumption can also degrade the nutritional content of nutritional substances. Finally, the consumer knows how he/she prepared the dinner, what condiments were added, and whether she did or did not enjoy it.

An interactive system and data base including dynamic nutritional substance labeling for collecting, preserving, measuring and/or tracking information about a nutritional substance in the nutritional substance supply system, would allow needed accountability. There would be nothing to hide. Unfortunately, today there is no such system or dynamic nutritional substance labeling.

Nutritional substance collectors and/or producers, such as growers (plants), ranchers (animals) or synthesizer (synthetic compounds), routinely create and collect information about their products, however, that information is generally not accessible by their customers. Even if such producers wished to provide such information to their customers, there is no current method of labeling, encoding or identifying each particular product to provide such information (even though all plants, animals and in general, nutritional substances have a natural fingerprint). While there are limited methods and systems available, they are excessively costly, time consuming, and do not trace, or provide access to, the nutritional substance organoleptic and/or nutritional state across the product's lifecycle. Current labels for such products include package labels, sticker labels and food color ink labels. These labels generally are applied to all similar products and cannot identify each particular product, only variety of products, such as apple banana, but not a particular banana or type of the nutritional evolution ΔN and the residual value at a moment of consumption.

An important issue in the creation, preservation, transformation, conditioning, and consumption of nutritional substances are the changes in nutritional, organoleptic, or aesthetic values, ΔN, that occur in nutritional substances due to a variety of internal and external factors. Because nutritional substances are composed of biological, organic, and/or chemical compounds, they are generally subject to degradation. This degradation generally reduces the nutritional, organoleptic, and/or aesthetic values of nutritional substances. While not always true, nutritional substances are best consumed at their point of creation. However, being able to consume nutritional substances at the farm, at the slaughterhouse, at the fishery, or at the food processing plant is at least inconvenient, if not impossible. Currently, the food and beverage industry attempts to minimize the loss of nutritional value (often through the use of additives or preservatives), and/or attempts to hide this loss of nutritional value from consumers.

Worse yet, deliberate tampering with food, for example by adulteration with inexpensive or lower quality components, in order to increase profitability, is a known problem that raises many issues, including serious health concerns. For instance meat, including beef, pork, fish and poultry, can be adulterated, with ground horsemeat being substituted at least in part for ground beef for example. Apart from personal preference, a consumer may be medically at risk from unwittingly consuming horsemeat, for a variety of reasons. The ability to accurately identify the contents of food, and all its components, is therefore important from many perspectives, including health and safety. Another concern may be substitution of “inorganic” food for claimed “organic” food, such as that grown without pesticides, genetically modified organisms, etc. in order to reduce cost, but at some health peril to the consumer, and the ability to detect such adulteration or counterfeiting is valuable.

The examples herein of some prior or related systems and their associated limitations are intended to be illustrative and not exclusive. Other limitations of existing or prior systems will become apparent to those of skill in the art upon reading the following Detailed Description.

### SUMMARY

Described herein is a method for indicating the adulteration of a nutritional substance, and, in certain embodiments, adulteration with horsemeat. The method includes assigning to the nutritional substance a first nutritional value at a first one of multiple modules including a creation module, preservation module, transformation module, conditioning module and consumer module, the nutritional value corresponding to a characteristic of a component of the nutritional substance, appending the first nutritional value as a record to the nutritional substance, assigning to the nutritional substance a second nutritional value at a second one of the multiple modules, appending the second nutritional value as a record to the nutritional substance, determining a change, ΔN, between the first and second nutritional values, performing a qualitative assessment of ΔN relative to one or more predetermined parameters, and indicating whether the nutritional substance has been adulterated based on the qualitative assessment.

Also described herein is system for indicating the adulteration of a nutritional substance, and, in certain embodiments, adulteration with horsemeat, so as to for example allow consumers to know if the meat contains horsemeat. The system includes an assignment module operable to assign a unique identifier to a nutritional substance for storage in a data base, an intake module operable to determine a first and a subsequent nutritional, organoleptic, and/or aesthetic value of the nutritional substance and to associate the first and subsequent values with the unique identifier in the data base, an assessment module operable to determine a change, ΔN, between the first and subsequent determined values and to perform a qualitative assessment of ΔN relative to one or more predetermined parameters stored in the data base in association with the unique identifier, and an alert module operable to issue an alert based on the qualitative assessment performed by the assessment module.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 shows a schematic functional block diagram of a nutritional substance supply system in accordance with certain embodiments;

FIG. 2 shows a graph representing a value of a nutritional substance which changes according to a change of condition for the nutritional substance;

FIG. 3 shows a schematic functional block diagram of a nutritional substance supply system in accordance with certain embodiments;

FIG. 4 shows a schematic functional block diagram of a nutritional substance supply relating to an alternate embodiment;

FIG. 5 shows a schematic of an information module relating to an embodiment herein; and

FIG. 6 is a block diagram of a system 602 for indicating the adulteration of a nutritional substance in accordance with certain embodiments.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION

All references cited herein are incorporated by reference in their entirety as though fully set forth. One skilled in the art will recognize many methods and materials similar or equivalent to those described herein, which could be used in the practice of the present invention. Indeed, the present invention is in no way limited to the methods and materials described.

The various methods and techniques described below provide a number of ways to carry out the application. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application is described in the context of certain embodiments and examples, it will be understood by those skilled in the art that the embodiments of the application extend beyond the specifically disclosed embodiments to other alternative embodiments and/or uses and modifications and equivalents thereof.

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

The following discussion provides a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “controller,” “computer,” “server,” and the like are used interchangeably herein, and may refer to any of the above devices and systems. It is understood that the communications systems discussed herein are only examples of how nutritional substance information, consumer information, or any other required information can be passed along, provided, forwarded, transmitted, updated, revised, accessed, received, or retrieved according to the present invention, and that any communication means or combination thereof known to one skilled in the art could be utilized.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

In some instances, the interconnection between modules is the internet, allowing the modules (with, for example, WiFi capability) to access web content offered through various web servers. The network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

The modules in the systems can be understood to be integrated in some instances and in particular embodiments, only particular modules may be interconnected.

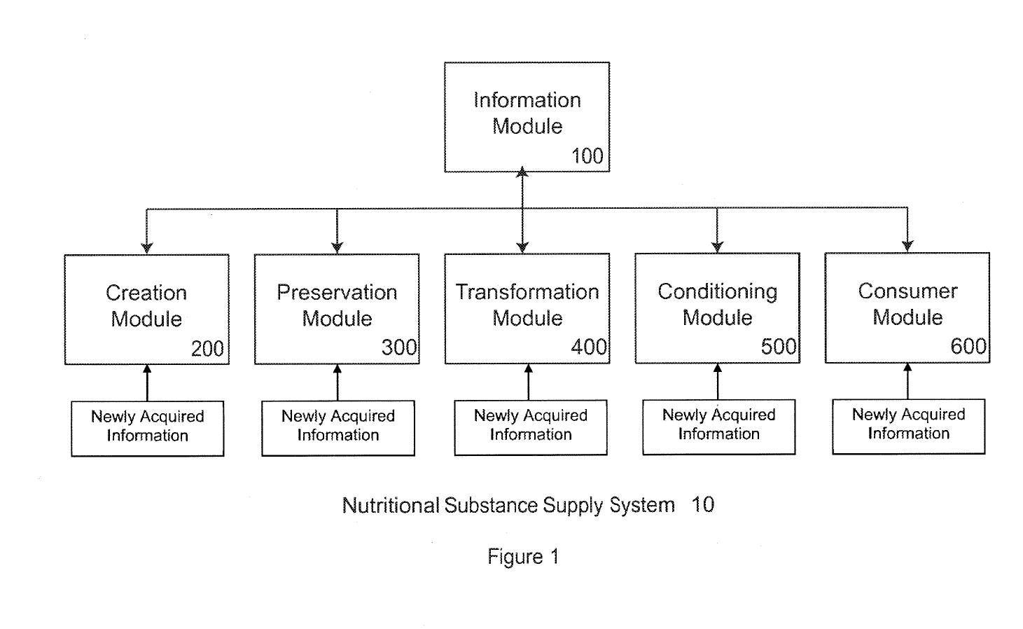

FIG. 1 shows the components of a nutritional substance industry 10. It should be understood that this could be the food and beverage ecosystem for human consumption, but could also be the feed industry for animal consumption, such as the pet food industry. In one embodiment, it is desirable for nutritional substance industry 10 is to create, preserve, transform and trace changes in nutritional, organoleptic and/or aesthetic values of nutritional substances, collectively and individually also referred to herein as ΔN, through their creation, preservation, transformation, conditioning and consumption. While the nutritional substance industry 10 can be composed of many companies or businesses, it can also be integrated into combinations of businesses serving many roles, or can be one business or even individual. Since ΔN is a measure of the change in a value of a nutritional substance, or a change in a characteristic of a component of the nutritional substance, knowledge of a prior value (or state) of a nutritional substance and the ΔN value will provide knowledge of the changed value (or state) of a nutritional substance, and can further provide the ability to estimate a change in value (or state).

Module 200 is a creation module. This can be a system, organization, or individual which creates and/or originates nutritional substances. Examples of this module include a farm which grows produce; a ranch which raises beef; an aquaculture farm for raising shrimp; a factory that synthesizes nutritional compounds; a collector of wild truffles; or a deep sea crab trawler.

Preservation module 300 operates to preserve and protect the nutritional substances created by creation module 200. Once the nutritional substance has been created, generally, it will need to be packaged in some manner for its transition to other modules in the nutritional substances industry 10. While preservation module 300 is shown in a particular position in the nutritional substance industry 10, following the creation module 200, it should be understood that the preservation module 300 actually can be placed anywhere nutritional substances need to be preserved during their transition from creation to consumption.

Transformation module 400 is a nutritional substance processing system, such as a manufacturer who processes raw materials such as grains into breakfast cereals, or meat into patties. In one embodiment transformation module 400 is a ready-to-eat dinner manufacturer who receives the components, or ingredients, also referred to herein as component nutritional substances, for a ready-to-eat dinner from preservation module 300 and prepares them into a frozen dinner. While transformation module 400 is depicted as one module, it will be understood that nutritional substances may be transformed by a number of transformation modules 400 on their path to consumption.

Conditioning module 500 is a consumer preparation system for preparing the nutritional substance immediately before consumption by the consumer. Conditioning module 500 can be a microwave oven, a blender, a toaster, a convection oven, a cook, etc. It can also be systems used by commercial establishments to prepare nutritional substances for consumers such as a restaurant, an espresso maker, pizza oven, and other devices located at businesses which provide nutritional substances to consumers. Such nutritional substances could be for consumption at the business or for the consumer to take out from the business. Conditioning module 500 can also be a combination of any of these devices used to prepare nutritional substances for consumption by consumers.

In one embodiment, consumer module 600 collects information from the living entity which consumes the nutritional substance which has passed through the various modules from creation to consumption. The consumer can be a human being, but could also be an animal, such as pets, zoo animals and livestock, which are they themselves nutritional substances for other consumption chains. Consumers could also be plant life which consumes nutritional substances to grow.

Information module 100 receives and transmits information regarding dynamically labeled nutritional substances between each of the modules in the nutritional substance industry 10 including, the creation module 200, the preservation module 300, the transformation module 400, the conditioning module 500, and the consumer module 600. The nutritional substance information module 100 can be an interconnecting information transmission system which allows the transmission of information between various modules. It is preferred that the information module 100 collects, tracks, and organizes information regarding the dynamically-labeled nutritional substances from each stage of the production of the nutritional substances from creation to consumption and that the information regarding the dynamically-labeled nutritional substances is openly available and openly integrated at any point in time to all modules of the nutritional substance supply system, preferably as soon as it is created. The integration and availability of the information is enabled by dynamic labeling provided with the nutritional substances, which includes a unique nutritional substance identifier, also referred to herein as a dynamic information identifier. Upon creation, the information relating to the nutritional substance is “appended” to the nutritional substance, either physically, by encoding, labeling, and the like as discussed below, or relationally, such that a stored record of the nutritional substance that includes its unique identifier and other data also contains that information, unambiguously associated with the nutritional substance through the unique identifier for reference, recollection, assessment, manipulation, modification, updating, and so on.

Information module 100 contains a database, also referred to herein as a dynamic nutritional value database, wherein the information regarding the dynamically labeled nutritional substance resides and can be referenced or located by the corresponding dynamic information identifier. The information contained in information module 100 comprises at least a portion of the labeling content for the corresponding nutritional substance, and can be accessed using reference information or encoding provided with the product, as will be explained further. Information module 100 can be connected to the other modules by a variety of communication systems, such as paper, computer networks, the Internet and telecommunication systems, such as wireless telecommunication systems. It is understood that the communications systems discussed herein are only examples of how nutritional substance information, consumer information, or any other required information can be provided, forwarded, transmitted, updated, revised, accessed, received, or retrieved according to the present invention, and that any communication means or combination thereof known to one skilled in the art could be utilized. In a system capable of receiving and processing real time consumer feedback and updates regarding changes in the nutritional, organoleptic, and/or aesthetic value of dynamically-labeled nutritional substances, or ΔN, consumers can even play a role in updating a dynamic nutritional value database with observed or measured information about the dynamically-labeled nutritional substances they have purchased and/or prepared for consumption, so that the information is available and useful to others in the nutritional substance supply system, such as through reports reflecting the consumer input or through modification of ΔN. In a system capable of receiving and processing creator, preserver, transformer, or conditioner updates regarding a ΔN or other attribute of dynamically-labeled nutritional substances they have created or processed, the creator, preserver, transformer, or conditioner can play a role in revising a dynamic nutritional value database with observed or measured or newly acquired information about the dynamically-labeled nutritional substances they have previously created or processed, so that the revised information is available and useful to others in the nutritional substance supply system, such as through reports reflecting such input or through modification of ΔN, or modification of information regarding the source, creation and other origin information for the nutritional substance.

A nutritional, organic or aesthetic value of a nutritional substance can include, be related to, or be determined from, its olfactory values. Typically, but not necessarily, olfactory values are detectable by the human sense of smell. However, nutritional substances may produce olfactory values, or in other words, they may emit or produce gaseous components or volatiles that are not detectable or discernible by the human sense of smell but, nevertheless, may be indicative of a particular state of the nutritional substance, such as a nutritional, organoleptic, or aesthetic value. Further, the difference between current information, such as current olfactory values of a particular nutritional substance, and historic information, such as prior olfactory values of the particular nutritional substance, can indicate a change in nutritional state of the substance, such as a change in nutritional, organoleptic, or aesthetic value. In addition, olfactory values of a nutritional substance can be indicative of contamination or adulteration of nutritional substances by other substances. In particular, ground meat patties that contain beef exclusively would have one characteristic odor, detectable by human or machine (or even animal, such as specially-trained dogs), while patties that have been adulterated partially or entirely with other substances, such as horsemeat, would have a different characteristic odor detectable by human or machine (or animal).

Colorimetric sensor arrays have been utilized for the detection and identification of coffee aromas, or in other words, their olfactory values (Anal Chem. 2010 March 1; 82(5): 2067-2073. doi: 10.1021/ac902823w). The colorimetric sensor array responses are effective for comparisons of coffees against a standard, for discrimination of subtle differences between similar coffee products, and for monitoring changes in a coffee product as a function of time or conditions. In one embodiment, a library of colorimetric sensor array responses are created for known nutritional substances, such as beef, in ground or other form, and the colorimetric sensor array response of a nutritional substance currently being analyzed is quantitatively compared to the library entries to determine what known nutritional substance the nutritional substance currently being analyzed is most like. Different proportions of adulteration, from 0% to 100%, can be identified in this manner.

A method for providing dynamic labeling content for a nutritional substance in one embodiment includes steps for gathering and providing information regarding adulteration of the nutritional substance. Information regarding adulteration of nutritional substances can come from various sources, not just detection of olfactory values as mentioned above.

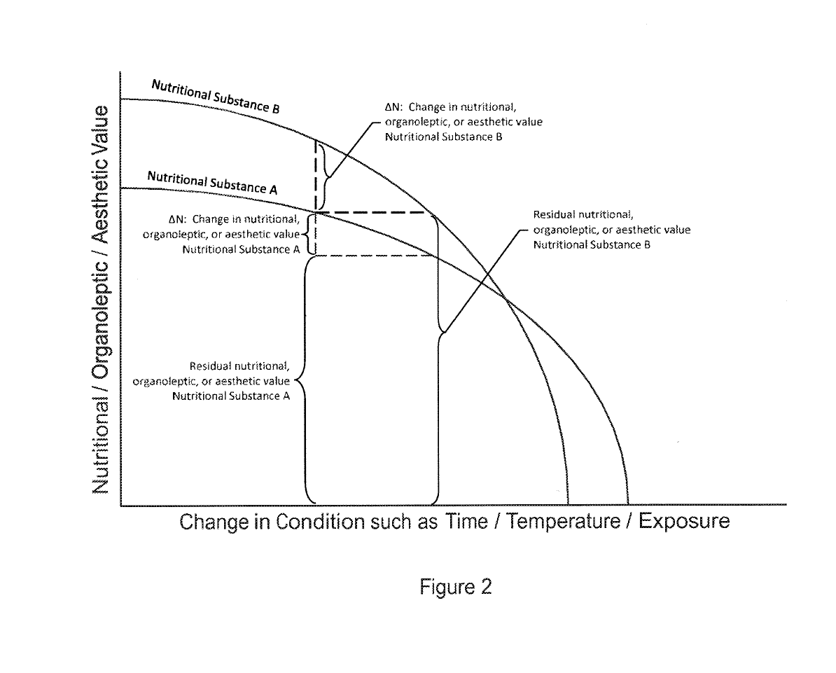

FIG. 2 is a graph showing the function of how a nutritional, organoleptic, or aesthetic value of a nutritional substance varies over the change in a condition of the nutritional substance. Plotted on the vertical axis of this graph can be either the nutritional value, organoleptic value, or even the aesthetic value of a nutritional substance. Plotted on the horizontal axis can be the change in condition of the nutritional substance, ΔN, over a variable such as time, temperature, location, and/or exposure to environmental conditions (this is indicated as “ΔN: Change in nutritional, organoleptic, or aesthetic value” in FIG. 2) In certain embodiments, the vertical axis represents the value of a characteristic associated with a particular component of interest, such as beef, so that a decrease in this characteristic value indicates a concomitant decrease in the proportion of beef, or increase in the level of adulteration, as by horsemeat.

Also shown in FIG. 2 is the residual nutritional, organoleptic, or aesthetic value of the nutritional substance (indicated by “Residual nutritional, organoleptic, or aesthetic value”). This exposure to environmental conditions can include: exposure to air, including the air pressure and partial pressures of oxygen, carbon dioxide, water, or ozone; airborne chemicals, pollutants, allergens, dust, smoke, carcinogens, radioactive isotopes, or combustion byproducts; adulteration, deliberate or otherwise, as by inferior products such as horsemeat; exposure to moisture; exposure to energy such as mechanical impact, mechanical vibration, irradiation, heat, or sunlight; or exposure to materials such as packaging.

In one example, the function plotted as nutritional substance A could show a ΔN for milk, such as the degradation of a nutritional value of milk over time. Any point on this curve can be compared to another point to measure and/or describe the change in nutritional value, or the ΔN of nutritional substance A. The plot of the degradation in the same nutritional value of nutritional substance B, also milk, describes the change in nutritional value, or the ΔN of nutritional substance B, a nutritional substance which starts out with a higher nutritional value than nutritional substance A, but degrades over time more quickly than nutritional substance A.

In certain embodiments, there is a ΔN as two or more nutritional substances combine. For example, when lemon is added to guacamole it keeps the avocado in the guacamole from turning black. The function plotted as nutritional substance A could show a ΔN for guacamole made by a first transformer, such as the degradation of an aesthetic value of guacamole over time, in this case a degradation of its green color. Any point on this curve can be compared to another point to measure and/or describe the change in aesthetic value, or the ΔN of nutritional substance A. The plot of the degradation in the same aesthetic value of nutritional substance B, a guacamole made by a second transformer, describes the change in the same aesthetic value, or the ΔN, of nutritional substance B. Nutritional substance B starts out with a higher aesthetic value than nutritional substance A, but degrades over time more quickly than nutritional substance A, for instance because the transformer of nutritional substance B adds less lemon juice to their guacamole in order not to distract from the flavor of the avocado. The information available is related to the interaction of the avocado and lemon juice in the respective manufacturer's guacamole, and can enable the consumer to make decisions related to the aesthetic value of the guacamole at a given point in time if nutritional substance A and nutritional substance B are provided with dynamic labeling, which would include a dynamic information identifier for each nutritional substance. Using the dynamic information identifier obtained from the dynamic labeling provided with each nutritional substance, the consumer could retrieve desired ΔN information, such as the aesthetic degradation profile referenced to each guacamole, from a dynamic nutritional value database. For example, if the consumer is purchasing the guacamole to consume at a time before the two curves intersect, and the decision is based on superior aesthetic value, the consumer will choose nutritional substance B. If the consumer is purchasing the guacamole to consume after the time the two curves intersect, and the decision is based on superior aesthetic value, the consumer will choose nutritional substance A, even though it has lower aesthetic value at the time of purchase.

In FIG. 1, creation module 200 in certain embodiments dynamically encodes nutritional substances, as part of the nutritional substance dynamic labeling, to enable the tracking of changes in nutritional, organoleptic, and/or aesthetic value of the nutritional substance, or ΔN. This dynamic encoding, also referred to herein as a dynamic information identifier, can replace and/or complement existing nutritional substance marking systems such as barcodes, labels, and/or ink markings. This dynamic encoding, or dynamic information identifier, can be used to make nutritional substance information from creation module 200 available to information module 100 for use by preservation module 300, transformation module 400, conditioning module 500, and/or consumption module 600, which includes the ultimate consumer of the nutritional substance.

One method for providing dynamically labeled nutritional substances with a dynamic information identifier by creation module 200, or any other module in nutritional supply system 10, includes an electronic tagging system, such as the tagging system manufactured by Kovio of San Jose, Calif., USA. Such thin film chips can be used not only for tracking nutritional substances, but can include components to measure attributes of nutritional substances, and record and transmit such information. Such information may be readable by a reader including a satellite-based system. Such a satellite-based nutritional substance information tracking system could comprise a network of satellites with coverage of some or all the surface of the earth, so as to allow the dynamic nutritional value database of information module 100 real time, or near real time updates about a ΔN of a particular nutritional substance. The dynamic information identifier can also be utilized by creators, preservers, transformers, and conditioners to change labeling content already residing in information module 100 for nutritional substances they have already provided to another entity according to newly acquired information. In turn, this information is openly available and openly integrated at any point in time to all constituents in the nutritional substance supply system. It is also preferred that this information becomes openly available and openly integrated as soon as it becomes available.

A method for marking a dynamically-labeled nutritional substance with a dynamic information identifier, includes, in certain embodiments, providing an actual printed alphanumeric code on the nutritional substance that can be scanned, such as by a smartphone with a camera running an application for reading alphanumeric characters, or might be manually entered by any member of the nutritional substance supply system. Another method of marking can include providing the nutritional substance with a barcode or an RF tag or a printed QR code (Quick Response Code).

Preservation module 300 includes packers and shippers of nutritional substances. The tracking of changes in nutritional, organoleptic, and/or aesthetic values, or a ΔN, during the preservation period within preservation module 300 allows for dynamic expiration dates for nutritional substances.

It should be noted that a dynamic expiration date need not be indicated numerically (i.e., as a numerical date) but could be indicated symbolically as by the use of colors—such as green, yellow and red employed on semaphores—or other designations. Information about changes in nutritional, organoleptic, and/or aesthetic values of nutritional substances, or ΔN, is particularly useful in the conditioning module 500, as it allows knowing, or estimating, the pre-conditioning state of the nutritional, organoleptic, and/or aesthetic values of the dynamically labeled nutritional substance, and allows for estimation of a ΔN associated with proposed conditioning parameters. The conditioning module 500 can therefore create conditioning parameters, such as by modifying existing or baseline conditioning parameters, which can exist as recipes and conditioning protocols available through the information module 100 or locally available through the conditioning module 500, to deliver desired nutritional, organoleptic, and/or aesthetic values after conditioning. Using information provided by information module 100, conditioning module 500 in certain embodiments provides the consumer with the actual, and/or estimated change in nutritional, organoleptic, and/or aesthetic values of a dynamically-labeled nutritional substance, or ΔN. Further, consumer feedback and updates regarding observed or measured changes in the nutritional, organoleptic, and/or aesthetic value of dynamically-labeled nutritional substances, or ΔN, can play a role in updating a dynamic nutritional value database with information about the dynamically-labeled nutritional substances consumers have purchased and/or prepared for consumption, so that the information is available and useful to others in the nutritional substance supply system, such as through reports reflecting the consumer input or through modification of ΔN. Such information regarding the change to nutritional, organoleptic and/or aesthetic value of the dynamically-labeled nutritional substance, or ΔN, could be provided not only to the consumer, but could also be provided to information module 100 for use by creation module 200, preservation module 300, transformation module 400, so as to track, and possibly improve nutritional substances throughout the entire nutritional substance supply system 10.

The information regarding nutritional substances provided by information module 100 to consumption module 600 can replace or complement existing information sources such as recipe books, food databases like www.epicurious.com, and Epicurious apps. Through the use of specific information regarding a dynamically-labeled nutritional substance from information module 100, consumers can use consumption module 600 to select nutritional substances according to nutritional, organoleptic, and/or aesthetic values. This will further allow consumers to make informed decisions regarding nutritional substance additives, preservatives, genetic modifications, origins, traceability, and other nutritional substance attributes that may also be tracked through the information module 100. This information can be provided by consumption module 600 through personal computers, laptop computers, tablet computers, and/or smartphones. Software running on these devices can include dedicated computer programs, modules within general programs, and/or smartphone apps.

Through the use of nutritional substance information available from information module 100 nutritional substance supply system 10 can track nutritional, organoleptic, and/or aesthetic value of dynamically-labeled nutritional substances. Using this information, dynamically-labeled nutritional substances travelling through nutritional substance supply system 10 can be dynamically valued and priced according to nutritional, organoleptic, and/or aesthetic values. For example, nutritional substances with longer dynamic expiration dates (longer shelf life) may be more highly valued than nutritional substances with shorter expiration dates. Additionally, nutritional substances with higher nutritional, organoleptic, and/or aesthetic values may be more highly valued, not just by the consumer, but also by each entity within nutritional substance supply system 10. This is because each entity will want to start with a nutritional substance with higher nutritional, organoleptic, and/or aesthetic value before it performs its function and passes the nutritional substance along to the next entity. Therefore, both the starting nutritional, organoleptic, and/or aesthetic value and the ΔN associated with those values are important factors in determining or estimating an actual, or residual, nutritional, organoleptic, and/or aesthetic value of a nutritional substance, and accordingly are important factors in establishing dynamically valued and priced nutritional substances.

The change to nutritional, organoleptic, and/or aesthetic value for an information-enabled nutritional substance, or ΔN, tracked through nutritional substance supply system 10 through nutritional substance information from information module 100 can be determined from measured information. However, some or all such nutritional substance ΔN information may be derived through measurements of environmental conditions of the nutritional substance as it travelled through nutritional substance supply system 10. Additionally, some or all of the information-enabled nutritional substance ΔN information can be derived from ΔN data of other information-enabled nutritional substances which have travelled through nutritional substance supply system 10. Information-enabled nutritional substance ΔN information can also be derived from laboratory experiments performed on other nutritional substances, which may approximate conditions and/or processes to which the actual information-enabled nutritional substance has been exposed. Further, consumer feedback and updates regarding observed or measured changes in the nutritional, organoleptic, and/or aesthetic value of information-enabled nutritional substances can play a role in updating ΔN information. Also, a creator, preserver, transformer, or conditioner may revise ΔN information, or information regarding other attributes of information-enabled nutritional substances they have previously created or processed, based upon newly acquired information affecting the ΔN or the other attributes.

In FIG. 1, information module 100 is operably connected to at least one of the following modules: creation module 200, preservation module 300, transformation module 400, conditioning module 500, and consumer module 600. Each module collects information from its associated tasks regarding a nutritional substance and provides such information to information module 100. Such information includes information regarding a ΔN and may further include source information and a dynamic information identifier. Additionally, information module 100 can provide such collected information to the other modules, as well as outside parties not part of nutritional substance industry 10, wherein such information may be accessible by referencing at least one of the dynamic information identifier and the source information.

Creation module 200 collects information regarding a particular nutritional substance, such as source information regarding the origin or genesis of the nutritional substance, information regarding the growing or raising of the nutritional substance, information regarding the harvesting or slaughtering of the nutritional substance and corresponding initial nutritional, organoleptic, or aesthetic values of the nutritional substance, and where the nutritional substance was delivered. This creation information can be delivered by creation module 200 to information module 100 by means of a communications network such as a telecommunications network and, preferably, a wireless telecommunications network. Further, if the creation module 200 learns of a change in the information originally provided to information module 100, such as a deviation in a fertilizer or pesticide used or the water used for irrigation, the creation module 200 could update the labeling content related to those attributes and residing in the information module 100.

In the case where nutritional substance is beef hamburger meat, the rancher would collect information regarding the lineage of the cow, where the cow was raised (open range, feed yard, etc.), what the cow was fed, the medical history of the cow, and what dietary supplements and drugs were given to the cow. The rancher would also collect information regarding the cow's date of birth and when the cow was sold or slaughtered and if slaughtered, corresponding initial nutritional, organoleptic, or aesthetic values of the resulting products. Additionally, the rancher knows of the cow's immunization history and any medications, supplements and vaccines the cow was given, such as hormones, antibiotics and nutritional supplements. Also the rancher has all the information of the cow's milk production cycle and of the rate of growth, if it has been free range grass fed or in a confined environment and the state and method used to have it slaughtered. This creation information can be monitored in real time through a local or global access network. All such creation information would be provided by the rancher to information module 100.

In various embodiments, methods and systems are provided to tag the origin information in or about the nutritional substance. As used herein, “origin” refers to, for example, location of a specific farm where the nutritional substance is grown, location of a ranch from where the meats and/or poultry originated, location of a fishery from where the fish are caught or reared, location of a seafood farms from where the seafood is cultivated, countries, cities, states, zip codes, or latitude and longitudinal positions of the origins of the nutritional substances, or a combination thereof. In some embodiments, the origin information may originate from the creator of the nutritional substance (such as from a farmer, a rancher, a fishery etc.). In other embodiments, the origin information may originate from facilities that read the origin information contained in the nutritional substances, such as labs that run assays to read the molecular tags contained in the nutritional substance.

A dynamically-labeled nutritional substance is encoded with a “unique information identifier” or an “information identifier”, also referred to herein as a dynamic information identifier, which correlates the dynamically-labeled nutritional substance with information about the nutritional substance including but not limited to its origin, its nutritional value, changes in nutritional, organoleptic, and/or aesthetic value of the nutritional substance (ΔN) or combinations thereof. The information identifier may also be used to, for example, relate the encoded nutritional substance with information stored in an information module, such as a storage system. The storage system may be a computer, a computer database, the cloud or a combination thereof.

Dynamic nutritional substance labeling may include tags which comprise information about the origin of the nutritional substance. The tags do not affect taste, texture or nutritional characteristics of the nutritional substance. The tags may be any one or more of a mechanical tag, an electronic tag, a molecular tag, a chemical tag or a combination thereof.

In some embodiments, the tag comprising the origin information is a label that is human readable. In some embodiments, the label is directly attached to the nutritional substance (for example, stuck on to the nutritional substance). In other embodiments, the label may be, indirectly attached to the nutritional substance (for example, attached on a package containing the nutritional substance). The label may further include all or partial information about the nutritional content of the nutritional substance. The information on the label may also be stored in the Information Module 100 such as a storage system. The label may further comprise an information identifier that links/connects the information contained on the label about a nutritional substance with the information stored in a storage system (for example, a computer, a database, on the cloud or a combination thereof) about the same nutritional substance. The storage system may contain additional information associated with the nutritional substance that is not present on the label (for example, additional details of the nutritional content of the nutritional substance). In some embodiments, the nutritional information contained on the label and/or in the storage system provides the starting value for calculating the change in nutritional content (ΔN) as the nutritional substance is transported from the creator to the consumer 600, either directly or indirectly, via any one or more of the preservation system 300, transformation system 400, conditioning system 500, or a combination thereof. As the nutritional substance moves through each of the aforementioned systems, the nutritional content/value information is updated in the Information Module 100 (storage system), thus providing a ΔN value and a more accurate representation of the nutritional content in the nutritional substance.

Examples of the benefits of the above-described technology for retrieving labeling content information about a nutritional substance can be related to the correction of labeling of nutritional substances that are intentionally or unintentionally mislabeled. For instance, there was an incident in Europe in 2013 where horsemeat was mislabeled as beef. Concerns arose because some of the horsemeat contained a powerful equine painkiller, phenylbutazone that, in high doses, is known to cause a potentially fatal blood disorder, aplastic anemia, rendering bone marrow unable to produce blood cells. As a result of this mislabeling incident, and specifically because of the lack of knowledge as to which products contained adulterated horsemeat and which did not, significant quantities of products were removed from the distribution chain and needlessly wasted from consumption.

The above-described technology for retrieving labeling content information about a nutritional substance could potentially be utilized to dynamically revise labels, when information is made available from transformers or conditioners, to indicate whether or not an erstwhile beef product contains horsemeat and an adulterating substance such as phenylbutazone. Dynamic re-labeling can warn or reassure, as the case may be. As a specific example, for consumers that do not want to eat horsemeat, dynamic labeling can identify either the presence or absence of horsemeat in a nutritional substance.

Furthermore, in the context of the above-described degradation curves, the dynamic labeling and content information could indicate the ΔN information for a meat product, with the particular degradation for beef and horsemeat indicated separately

Even without providing dynamic label or content information, the information system can provide a platform for providing access to relevant information to consumers at almost any stage they request it. Indeed, the embodiments herein allow consumers to make informed decisions, to become aware of nutritional fraud and tampered products and, additionally, to access information on the actual ΔN nutritional, organoleptic and esthetic values of the nutritional substances that are offered for their consumption.

In addition, dynamic labeling can indicate the date on which the information about the nutritional content, or the ΔN of the nutritional substance, is current; in other words, might indicate whether the label reflects currently-available information, such as, for instance, contamination of beef by mixing with a substance containing phenylbutazone. Knowledge that label information in up-to-date can, in and of itself, be valuable information.

In another embodiment of the present invention, such information could be mapped out regarding the creation, packaging, transformation, and conditioning of the nutritional substance and is used by a subsequent user or consumer of the nutritional substance to modify their use, preservation, transformation and/or conditioning of the nutritional substance.

In another embodiment of the present invention, such information could be mapped out regarding the creation, packaging, transformation, and conditioning of the nutritional substance to be used by a consumer of the nutritional substance to confirm that their intended use, preservation, transformation and/or conditioning of the nutritional substance will result in a nutritional substance that meets their needs, particularly as it relates to a ΔN of the nutritional substance.

It can be appreciated that various embodiments of the present invention can be used to dynamically update nutritional content labels and other product information without the need to re-label food products or recall product for relabeling. Also, the availability of dynamically updated nutritional information can be used at the time of sale of a nutritional product, not only to assure the buyer that a purchased product contains a desired ingredient (or does not contain an undesired component) but also to provide conformational information to a seller.

In further embodiments, the tags comprising the origin information may be computer readable, such as mechanical tags. Such tags include but are not limited to Quick Response (QR) tags, barcodes, infrared tags or magnetic tags. Such computer readable tags may be on, for example, a sticker, that is directly (e.g. on the skin of a pineapple) or indirectly (e.g. on a bushel of apples, wherein each apple in the bushel has the same origin and same or very similar nutrient content) associated with the nutritional substance. These tags may further contain all or partial information about the nutritional content of the nutritional substance. These tags may further comprise an information identifier that links/connects the information contained on the mechanical tag about a nutritional substance with the information stored in an Information Module 100 such as a storage system (for example, a computer, a database, on the cloud or a combination thereof) about the same nutritional substance. The storage system may contain additional information associated with the nutritional substance that is not present on the tags (for example, additional details of the nutritional content of the nutritional substance). The nutritional information contained in the mechanical tags and/or in the storage system provides starting values for calculating the change in nutritional content (ΔN) as the nutritional substance is transported from the creator to the consumer 600, either directly or indirectly, via any one or more of the preservation system 300, transformation system 400, conditioning system 500, or a combination thereof. As the nutritional substance moves through each of the aforementioned systems, the nutritional content information is updated in the Information Module 100 (storage system), thus providing a ΔN value and a more accurate representation of the nutritional content in the nutritional substance.

In additional embodiments, the tags comprising origin information may be electronic tags such as radio frequency identification (RFID) tags (U.S. Pat. Nos. 8,314,701; 6,671,698; 6,182,725; 6,888,458; 7,256,699; 7,403,855). Such electronic tags may be on, for example, a sticker, that is directly (e.g. on the skin of a pineapple) or indirectly (e.g. on a bushel of apples, wherein each apple in the bushel has the same origin and same or very similar nutrient content) associated with the nutritional substance. These tags may further contain all or partial information about the nutrient content and nutritional value in the nutritional substance. These tags may further comprise an information identifier that links/connects the information contained on the mechanical tag about a nutritional substance with the information stored in a storage system (for example, a computer, a database, on the cloud or a combination thereof) about the same nutritional substance. The storage system may contain additional information associated with the nutritional substance that is not present on the tags (for example, additional details of the nutritional content of the nutritional substance). The nutritional information contained in the electronic tags and/or in the storage system provides starting values for calculating the change in nutritional content (ΔN) as the nutritional substance is transported from the creator to the consumer 600, either directly or indirectly, via any one or more of the preservation system 300, transformation system 400, conditioning system 500, or a combination thereof. As the nutritional substance moves through each of the aforementioned systems, the nutritional content information is updated in the Information Module 100 (storage system), thus providing a ΔN value and a more accurate representation of the nutritional content in the nutritional substance.

The electronic tags may further encode, for example, Uniform Resource Locators (URLs) such that when scanned, the user is directed to an Information Module (storage system) that includes information about the nutritional substance. Electronic tags require a reader module (240) to retrieve the information stored in the tags. In some embodiments, reading of the electronic tags with a reader may trigger a website to be launched that has information including but not limited to the nutritional content, caloric content, growth conditions and the precise locations of creation of the nutritional substance. Alternatively, reading of the electronic tags with a reader may trigger a file to be downloaded that comprises the aforementioned information. The readers include but are not limited to scanners or WAN devices (such as smartphones).

In various embodiments, molecular tags may be used to correlate the origin of nutritional substances to their origin. For example, a unique set of genetic and epigenetic fingerprints may be used to trace the origins of nutritious substances. Such fingerprints may be naturally occurring in the nutritious substances or nutritious substances may be modified to express such fingerprints. For example, if the genome of the apple seeds in country 1 are modified to express long-term-repeat (LTR) sequence 1 and produce bushel-1 of apples and genome of apple seeds for apples grown in country 2 are modified to express LTR2 and produce bushel-2 of apples, sequencing the apples from each bushel can provide information about the origin of the apple. The LTR sequence is unique to each origin. The information about the LTR sequences associated with each bushel of apples and the associated country may be stored in a storage system such as a computer, a computer database the cloud or a combination thereof.

In some embodiments, plant based nutritional substances can be analyzed for presence or absence of naturally occurring microorganisms that live synergistically with the plant. The types and/or numbers of microorganisms may form a unique molecular fingerprint allowing correlation of a nutritional substance to its origin. Differences in environmental queues may result in distinct varied microbial presence in plants. For example, oranges from Florida may have a different microbial biome compared to those from California. Such differences may serve as signatures of origins of nutritional substances. In some embodiments, cultivation-dependent methods to detect microorganisms include but are not limited to PCR, RFLP, fatty acid profiles (FAME), and nutritional (Biolog), and may be used to characterize specific groups of plant-associated bacteria and fungi. Cultivation-independent PCR-based microorganism fingerprinting techniques to study small subunit (SSU) rRNA genes (rDNA) in the prokaryote microbial fraction may be used to study diversity, structural composition and dynamics of microbial communities associated with plants. For example, using terminal restriction length polymorphism, (T-RFLP) in a study of corn-associated bacteria, signals related to Cytophaga/Bacteroides/Flavobacterium phylum, Holophaga/Acidobacterium phylum, α-proteobacteria, β-proteobacteria and γ-proteobacteria were detected (Montesinos, E. Int Microbiol 2003 Vol 6 221-223). Similarly, microbial patterns (presence, absence, numbers and identities of microorganisms) may be used as fingerprints to correlate nutritional substances to their origins.

Expressions of various proteins in nutritional substances may also be used to correlate nutritional substances to their origins. In virtually all organisms, various stress conditions result in various genes being up- or down-regulated, resulting in a distinct protein profile (Sinclair, D. and Guarente, L., Scientific American March 2006 pp 48-57; Diller, K., Annual Review of Biomedical Engineering 2006 vol 8:403-424; Zerebecki R A, Sorte C J B (2011) PLoS ONE 6(4): e14806). In some embodiments, fruits and vegetables grown under drought conditions or nutrient-poor soil conditions may have a different protein profile compared to the same fruits and vegetables grown under drought-free and nutrient-rich soil conditions (Fu-Tai, Ni, Current Genomics 2009 Vol 10 269-280). For example, a correlation between levels of photosynthesis and transcription under stress was observed and differences in the number, type and expression levels of transcription factor families were also identified under drought and recovery between the three maize landraces (Hayano-Kanashiro, C et al., PLoS One 2009 Vol 4(10) e7531 1-19). Methods for analyzing protein expression will be known to one skilled in the art and include but are not limited to methods discussed in “Protein Methods”, 2nd Edition by Daniel M. Bollag, Michael D. Rozycki and Stuart J. Edelstein (1996) Published by Wiley Publishers or in Kingsmore, S., Nature Reviews Drug Discovery 5, 310-321 (April 2006).

The micronutrient content of a nutritional substance may vary based on conditions including but not limited to any one or more of environmental, soil, growth, water, light etc. In some embodiments, the micronutrient content in nutritional substances may be used to correlate a nutritional substance to its origin. For example, the blackberry phenolic composition and concentrations are influenced by genetics, growing conditions, and maturation and, for example, changes in growing conditions may alter changes in phenolic composition (Kaume, L. et al., J. Agric. Food Chem., 2012, 60 (23), pp 5716-5727). This may serve as a marker for associating various batches of blackberries with their origin. In another example, aloe vera comprises three main components: glucose; malic acid; and the polysaccharide acemannan, which is composed of a long chain of mannose monomers. On average, each mannose monomer ring has one acetate group attached to one of three available positions. Using nuclear magnetic resonance (NMR), the profiles of different acetate groups represent a fingerprint for aloe vera and its origin (Perks, B., Chemistry World 2007 49-52). Pure varieties of coffee beans may be distinguished according to profiles of analytes such as sterols, fatty acids and total amino acids. Mixtures may be characterized using, for example, Fourier transform infrared spectroscopy (FTIS). Since the beans contain different amounts of the two main coffee compounds—chlorogenic acid and caffeine—which have distinctive infrared spectra, FTIS may be used to trace coffee beans to their origins (Perks, B., Chemistry World 2007 49-52). Similarly, the micronutrient content of various nutritional substances may be used to trace a nutritional substance to its origin.

In further embodiments, mitochondrial DNA may be PCR amplified and sequenced to trace a nutritional substance to its origin. For example, analyzing mitochondrial DNA, 20 species of sardines (genera such as Sardina, Sardinella, Clupea, Ophistonoma and Ilisha) and a similar number of horse mackerel species (Trachurus, Caranx, Mullus, Rastrelliger and others), originating from seas all over the world, were identified (Fatima C. et al., European Food Research and Technology, 2011, 232(6):1077-1086; Fatima C. et al., Journal of Agricultural and Food Chemistry, 2011; 59 (6): 2223-2228).

In various embodiments, differences in biosynthetic pathways may be used to trace nutritional substances to their origin or to determine the purity and/or quality of nutritional substances. For example, differences in biochemical pathways are used to identify corn-fed chicken, which are more expensive. The analytical method exploits the differences between the biosynthetic pathways that exist between maize (C4 pathway) and temperate cereals such as wheat and barley (C3 pathway). C3 and C4 plants provide differenct ¹³C/¹²C ratios when measured using stable isotope ratio mass spectrometry. Comparison with a database of results from chickens fed differing maize diets provides a means of confirming that a chicken was fed on corn (maize) (Perks, B., Chemistry World 2007 49-52).

In additional embodiments, arrays, including but not limited to sensor-arrays may be used to trace nutritional substances to their origins and/or to determine the origin of nutritional substances from a mixture thereof. For example, colorimetric sensor arrays may be used to distinguish between a variety of coffee beans using their aromas (Suslick et al., Anal Chem 2010 82(5):2067-2073).

Various other technologies may be used to correlate nutritional substances to their origins including but not limited to nanotechnology, chromatography, mass spectrometry, electronic noses, determining carbon isotope ratios, quantitative SNP genotyping. Additionally, nutritional substances may be genetically modified with, for example, long terminal repeat (LTR) sequences which would serve as unique fingerprints for the nutritional substance. For example, bananas from Mexico may express a LTR sequence that is different compared to the bananas from India. Various genetic and DNA profiling processes may be used to correlate nutritional substances to their origin and would be apparent to a person of skill in the art. Such methods include but are not limited to restriction fragment length polymorphism (RFLP) analysis, polymerase chain reaction (PCR) analysis, short tandem repeats (STR) analysis, amplified fragment length polymorphism (AmpFLP) analysis, mitochondrial DNA analysis or combinations thereof.

A nutritional substance encoding a molecular tag may further comprise an associated label, mechanical tag and/or electronic tag. The information about the nutritional substance and the encoded molecular tag about the origin is stored in a storage system. The nutritional content values may provide the starting values for calculating the change in nutritional content (ΔN) as the nutritional substance is transported from the creator to the consumer 600, either directly or indirectly, via any one or more of the preservation system 300, transformation system 400, conditioning system 500, or a combination thereof. As the nutritional substance moves through each of the aforementioned systems, the nutritional content information is updated in the Information Module 100, thus providing a ΔN value and a more accurate representation of the nutritional content in the nutritional substance.

Optionally, the tags may also include information about the nutritional content of the nutritional substance. In some embodiments, information about the creation/origin and the nutritional content of a nutritional substance is on the same tag. Additionally, a single electronic or mechanical tag may encode a unique information identifier that directs a user to a storage system that includes information about the origin, nutritional content and nutritional value of the nutritional substance. A single electronic tag or a single mechanical tag may encode information about the origin and the nutritional content of a nutritional substance. Alternately, a single electronic tag or a single mechanical tag may encode information about the origin and a unique information identifier associated with the nutritional substance. In some embodiments, a single electronic tag or a single mechanical tag may encode information about the origin, the unique information identifier and the nutritional content of a nutritional substance.

Optionally, different tags comprise information about the origin, nutritional content and a unique information identifier for each nutritional substance. For example, a molecular tag (such as a unique nucleic sequence identifier or a unique protein expression pattern) may provide information about the origin of a nutritional substance and a mechanical tag may provide information about the nutritional content and/or a unique information identifier for the nutritional substance

Preservation module 300 preserves a nutritional substance during its journey from the creation module 200 to the transformation module 400. However, it is understood that preservation module 300 may be located between any two modules for the transfer of nutritional substance between those modules. For example, not only does the nutritional substance need to be preserved between creation module 200 and transformation module 400, it also needs to be preserved between transformation module 400 and conditioning module 500. Preservation module 300 obtains source or creation information regarding the nutritional substance from information module 100. Using that information, preservation module 300 may dynamically adapt or modify its preservation process for the nutritional substance to optimize the preservation of the nutritional substance so as to preserve or improve or minimize degradation of at least one of the nutritional, organoleptic, or aesthetic properties of the nutritional substance. In other words, the preservation module 300 can act to optimize at least one ΔN associated with the nutritional substance resulting from preservation.

Additionally, preservation module 300 provides information to information module 100 regarding the nutritional substance during the time it is being preserved and shipped to transformation module 400. This information could include the condition, including a nutritional, organoleptic, or aesthetic value of the nutritional substance when it was received for preservation, the condition, including a nutritional, organoleptic, or aesthetic value of the nutritional substance during its preservation, and the condition, including a nutritional, organoleptic, or aesthetic value of the nutritional substance at the end of its preservation. Additionally, such preservation information could include the environmental conditions outside the preservation module 300 during the period of preservation and shipment. Preservation module 300 could also provide information regarding the interior conditions of preservation module 300 during the preservation and shipment of the nutritional substance. Finally, if preservation module 300 dynamically modified its preservation of the nutritional substance during its preservation and shipment, information regarding how preservation module 300 dynamically modified itself during the period of preservation and shipment could be provided to information module 100. Still further, if the preservation module 300 learns of a change in the information originally provided to information module 100, such as a deviation in storage conditions, the preservation module 300 could update the labeling content related to those attributes and residing in the information module 100.

In the case where the nutritional substance is beef which is being aged during the period it is preserved by preservation module 300, preservation module 300 could provide information module 100 with information regarding the condition, including a nutritional, organoleptic, or aesthetic value of the beef from the time of its delivery to preservation module 300, through the time the beef was preserved by preservation module 300, to when it was removed from preservation module 300. This preservation information provided to information module 100 is preferably a ΔN occurring during the preservation period, or used to determine a ΔN occurring during the preservation period, and could be used by the conditioner of the beef, such as a restaurant, to determine how to properly cook the beef.

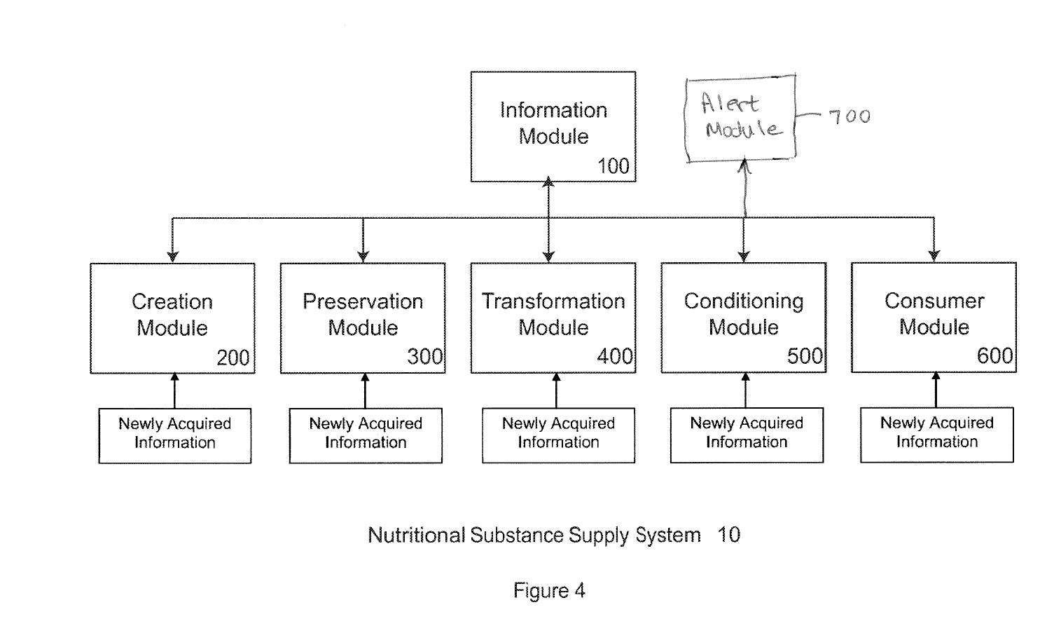

Transformation module 400 could retrieve from information module 100 both; creation information provided by creation module 200, such as source information regarding the origin or genesis of the nutritional substance, information regarding the growing or raising of the nutritional substance, information regarding the harvesting or slaughtering of the nutritional substance and corresponding initial nutritional, organoleptic, or aesthetic values of the nutritional substance; and preservation information provided by preservation module 300. Transformation module 400 could use such creation information and preservation information to dynamically adapt or modify the transformation of the nutritional substance to optimize at least one ΔN associated with the nutritional substance resulting from transformation. Additionally, transformation module 400 could provide information module 100 with transformation information. Further, if the transformation module 400 learns of a change in the information it originally provided to information module 100, such as a deviation in component nutritional substance used, for example by adulteration with an inferior or less preferable component, such as horsemeat or a byproduct thereof, the transformation module 400 could update the labeling content related to those component nutritional substances and residing in the information module 100. As explained with reference to FIG. 4 below, transformation module 400, or any other module, including information module 100 or a dedicated module, may be configured to send out alerts or notifications to interested parties, such as regulatory agencies, consumers, retailers, handlers and the like, to provide indications of the adulteration. Various prohibited components associated with a particular food (horsemeat in the case of beef for instance) can be tracked and used as a basis for the alerts. In certain embodiments, this is performed through tracking of ΔN. Specifically, when beef is the nutritional substance being dynamically labeled and monitored by the system 10, then the detected presence of horsemeat, to any predetermined degree, would trigger an alert. Such detection can be made through qualitative analysis determining if ΔN for beef, relating to the presence in it of horsemeat to any degree, rises above a threshold, for example 0%; or, conversely, by determining if ΔN, relating to the presence beef, falls below a predetermined value, such as 100%.

However, if horsemeat itself is the nutritional substance being dynamically labeled and monitored, then the detection of horsemeat would of course not be problematic and no alerts would need to be issued. The detection of various prohibited or undesired pharmaceuticals in the horsemeat, however, would be problematic and could be the basis of an alert. Therefore, in general, the indications of adulteration are functions of predetermined parameters that in certain embodiments are specific to the particular nutritional substance of interest and that are determined through qualitative assessments. Indications of adulteration for ground beef patties can be any presence of horsemeat—that is the threshold is 0%, and any value greater than 0% would trigger an indication and possibly an alert. (Or, conversely, anything below 100% beef). For horsemeat, on the other hand, the presence of phenylbutazone, at a predetermined threshold x, would trigger the indication and/or alert.

By reading and then transmitting source information or a dynamic information identifier unique to a nutritional substance, the conditioning module 500 will be able to recognize the nutritional substance from information it retrieves from a nutritional substance database, such as a dynamic nutritional value database. Various conditioning modules can retrieve this information and will adapt a conditioning protocol according to the information retrieved regarding the nutritional substance. In this way, a conditioning module 500 receives information regarding the nutritional substance from information module 100. This information could include: creation information provided by creation module 200, preservation information provided by preservation module 300, and transformation information from transformation module 400. Additionally, conditioning module 500 could receive recipe information from information module 100, consumer information through consumer module 600 or through consumer queries obtained through a consumer interface provided as part of the conditioning module 500. All such information could be used by conditioning module 500 in the conditioning of the nutritional substance so as to optimize at least one ΔN from conditioning. Additionally, conditioning module 500 can provide information module 100 with conditioning information regarding how the nutritional substance was conditioned, as well as measured or sensed or estimated information as to the state of the nutritional substance before, during and upon completion of conditioning, or a ΔN associated with conditioning.

Consumer module 600 obtains consumer information from the consumer of the nutritional substance. Such consumer information could include feedback from the consumer as to the quality and taste of the nutritional substance, and could include feedback used to understand or determine a nutritional, organoleptic, or aesthetic value of the nutritional substance. Consumer module 600 provides such information to information module 100. Information module 100 correlates this information with all the information provided regarding the nutritional substance and provides some or all consumer information to the various modules in nutritional substance supply system 10. Each module in the nutritional substance supply system 10 could use such consumer information to modify or improve its operation. Additionally, consumer module 600 could obtain information from the consumer as to the effectiveness of the marketing of the nutritional substance consumed. This information can also be provided to others for general consumer satisfaction information for other purposes, such as development of new nutritional substances, modification of existing nutritional substances, discontinuation of nutritional substances, or marketing of nutritional substances.

It should be understood that nutritional substances do not need to necessarily pass through all the modules in nutritional substance supply system 10.

It will also be understood that nutritional substances may pass through nutritional substance supply system 10 more than one time.

It will be additionally understood that for certain complex nutritional substances such as a frozen ready-to-eat dinner, a plurality of nutritional substances may travel through nutritional substance supply system 10 to be transformed by transformation module 400 into the complete ready-to-eat dinner which is eventually conditioned by conditioning module 500. The plurality of nutritional substances used to form the ready-to-eat dinner would each be tracked through nutritional substance supply system 10, where information module 100 receives and provides information regarding the component nutritional substances used in the ready-to-eat dinner.

Information module 100 can be implemented as a computer hosted database such as a flat database, or a relational database. Preferably, information module 100 is a multi-dimensional database. Preferably, information module 100 is set up as and intelligent database, capable of creating traffic and signing on the address of consumers, which would be a key source of business and also allow for the rapid adoption of nutritional information systems according to the present invention.

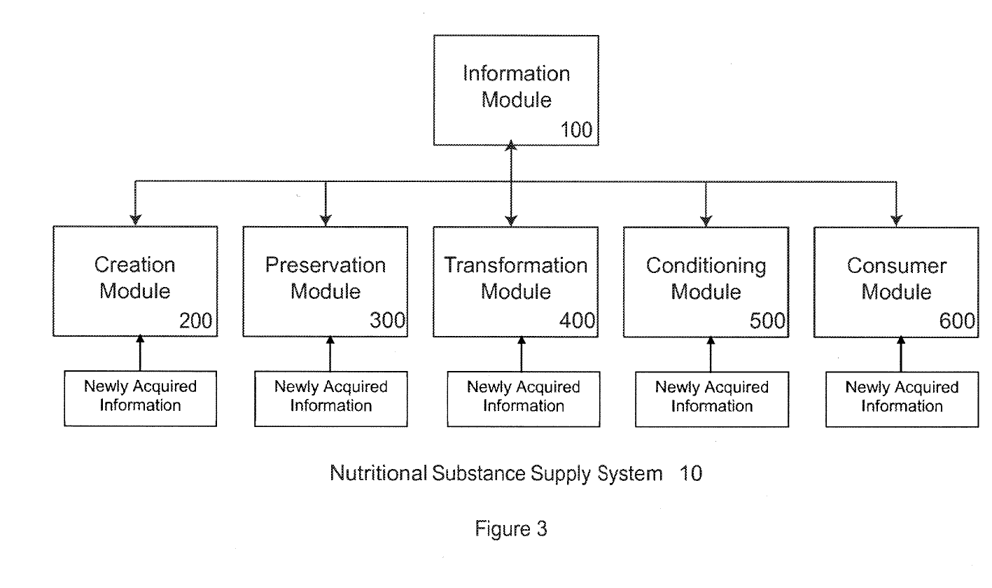

In FIG. 3, information module 100 is operably connected to at least one of the following modules: creation module 200, preservation module 300, transformation module 400, conditioning module 500, and consumer module 600. Each module collects information from its associated tasks regarding a nutritional substance and provides such information to information module 100. Such information includes information regarding a ΔN and may further include source information and a dynamic information identifier. Additionally, information module 100 can provide such collected information to the other modules, as well as outside parties not part of nutritional substance industry 10, wherein such information may be accessible by referencing at least one of the dynamic information identifier and the source information.

Creation module 200 collects information regarding a particular nutritional substance, such as source information regarding the origin or genesis of the nutritional substance, information regarding the growing or raising of the nutritional substance, information regarding the harvesting or slaughtering of the nutritional substance and corresponding initial nutritional, organoleptic, or aesthetic values of the nutritional substance, and where the nutritional substance was delivered. This creation information can be delivered by creation module 200 to information module 100 by means of a communications network such as a telecommunications network and, preferably, a wireless telecommunications network.

In the case where nutritional substance is beef hamburger meat, the rancher would collect information regarding the lineage of the cow, where the cow was raised (open range, feed yard, etc.), what the cow was fed, the medical history of the cow, and what dietary supplements and drugs were given to the cow. The rancher would also collect information regarding the cow's date of birth and when the cow was sold or slaughtered and if slaughtered, corresponding initial nutritional, organoleptic, or aesthetic values of the resulting products. All such creation information would be provided by the rancher to information module 100.

Preservation module 300 preserves a nutritional substance during its journey from the creation module 200 to the transformation module 400. However, it is understood that preservation module 300 may be located between any two modules for the transfer of nutritional substance between those modules. For example, not only does the nutritional substance need to be preserved between creation module 200 and transformation module 400, it also needs to be preserved between transformation module 400 and conditioning module 500. Preservation module 300 obtains source or creation information regarding the nutritional substance from information module 100. Using that information, preservation module 300 may dynamically adapt or modify its preservation process for the nutritional substance to optimize the preservation of the nutritional substance so as to preserve or improve or minimize degradation of at least one of the nutritional, organoleptic, or aesthetic properties of the nutritional substance. In other words, the preservation module 300 can act to optimize at least one ΔN associated with the nutritional substance resulting from preservation.

Additionally, preservation module 300 provides information to information module 100 regarding the nutritional substance during the time it is being preserved and shipped to transformation module 400. This information could include the condition, including a nutritional, organoleptic, or aesthetic value of the nutritional substance when it was received for preservation, the condition, including a nutritional, organoleptic, or aesthetic value of the nutritional substance during its preservation, and the condition, including a nutritional, organoleptic, or aesthetic value of the nutritional substance at the end of its preservation. Additionally, such preservation information could include the environmental conditions outside the preservation module 300 during the period of preservation and shipment. Preservation module 300 could also provide information regarding the interior conditions of preservation module 300 during the preservation and shipment of the nutritional substance. Finally, if preservation module 300 dynamically modified its preservation of the nutritional substance during its preservation and shipment, information regarding how preservation module 300 dynamically modified itself during the period of preservation and shipment could be provided to information module 100.

In the case where the nutritional substance is beef which is being aged during the period it is preserved by preservation module 300, preservation module 300 could provide information module 100 with information regarding the condition, including a nutritional, organoleptic, or aesthetic value of the beef from the time of its delivery to preservation module 300, through the time the beef was preserved by preservation module 300, to when it was removed from preservation module 300. This preservation information provided to information module 100 is preferably a ΔN occurring during the preservation period, or used to determine a ΔN occurring during the preservation period, and could be used by the conditioner of the beef, such as a restaurant, to determine how to properly cook the beef.

Transformation module 400 could retrieve from information module 100 both; creation information provided by creation module 200, such as source information regarding the origin or genesis of the nutritional substance, information regarding the growing or raising of the nutritional substance, information regarding the harvesting or slaughtering of the nutritional substance and corresponding initial nutritional, organoleptic, or aesthetic values of the nutritional substance; and preservation information provided by preservation module 300. Transformation module 400 could use such creation information and preservation information to dynamically adapt or modify the transformation of the nutritional substance to optimize at least one ΔN associated with the nutritional substance resulting from transformation. Additionally, transformation module 400 could provide information module 100 with transformation information.

Information module 100 could track the nutritional substances consumed to track and manage the diets of consumers. For example, a consumer who is on dialysis must manage the levels of certain chemicals in their blood for the dialysis to be effective. Information module 100 could track such information regarding nutritional substances being consumed. Additionally, information module 100 could provide information to consumer module 600 to assist in nutritional substance selection, including menu planning. This could include not only suggestions as to nutritional substances to be consumed, but also nutritional substances that should not be consumed and alerts or warnings when a consumer may be considering the purchase, consumption, or conditioning of a nutritional substance that should not be consumed. Further, such information from information module 100 could allow consumer module 600 to suggest compromises in the selection of nutritional substances.

In FIG. 4, information module 100 is operably connected to at least one of the following modules: creation module 200, preservation module 300, transformation module 400, conditioning module 500, and consumer module 600. Each module collects information from its associated tasks regarding a nutritional substance and provides such information to information module 100. Such information includes information regarding a ΔN and may further include source information and a dynamic information identifier. Additionally, information module 100 can provide such collected information to the other modules, as well as outside parties not part of nutritional substance industry 10, wherein such information may be accessible by referencing at least one of the dynamic information identifier and the source information.

As mentioned above, transformation module 400, or any other module, including information module 100 or a dedicated module, may be configured to send out alerts or notifications to interested parties, such as regulatory agencies, consumers, retailers, handlers and the like, to provide indications of the adulteration. Various prohibited components associated with a particular food (horsemeat in the case of beef for instance) can be tracked and used as basis for the alerts. Specifically, when beef is the nutritional substance being dynamically labeled and monitored by the system 10, then the detected presence of horsemeat would trigger an alert. However, if horsemeat itself is the nutritional substance being dynamically labeled and monitored, then the detection of horsemeat would of course not be problematic and no alerts would need to be issued. The detection of various prohibited pharmaceuticals in the horsemeat, however, would be problematic and could be the basis of an alert. As seen in FIG. 4, an alert module 700 is operationally coupled to the other modules for providing the alert functionality. In alert module 700 or any other module, a determination is made whether a detected component in the nutritional component should trigger an alert—that is, horsemeat in a ground beef patty, or a prohibited tranquilizer in horsemeat. An alert is then sent if the alert condition is met, to any interested party, such as the authorities, regulatory agencies, consumers, retailers, and the like. In certain embodiments, in addition to the triggering of alerts, the labeling of the nutritional substance is altered or updated to reflect the newly-discovered adulteration.

Information module 100 is preferably implemented as a massive, multidimensional database operated on multiple computing devices across an interconnecting network. Such a database could be hosted by a plurality of nutritional substance creators, preservers, transformers, conditioners, or consumers. Preferably, information module 100 is maintained and operated by a global entity which operates the system for the benefit of all participants in the nutritional substance supply system 10. In such an information module 100, the global entity could be remunerated on a per-transaction basis for receiving nutritional substance information or providing nutritional substance information.

In another business model for the global entity operating information module 100, access to the module by participants in the supply chain could be at no charge. However, the global entity could receive remuneration for access by non-participants such as research and marketing organizations. Alternatively, participants in the supply chain could pay to advertise to other participants in the supply chain as part of their access to the information in information module 100.

Information transfer throughout nutritional substance supply system 10, to and from information module 100 can be accomplished through various computer information transmission systems, such as the internet. Such interconnection could be accomplished by wired networks and wireless networks, or some combination thereof. Wireless networks could include WiFi local area networks, Bluetooth networks, but preferably wireless telecommunication networks.

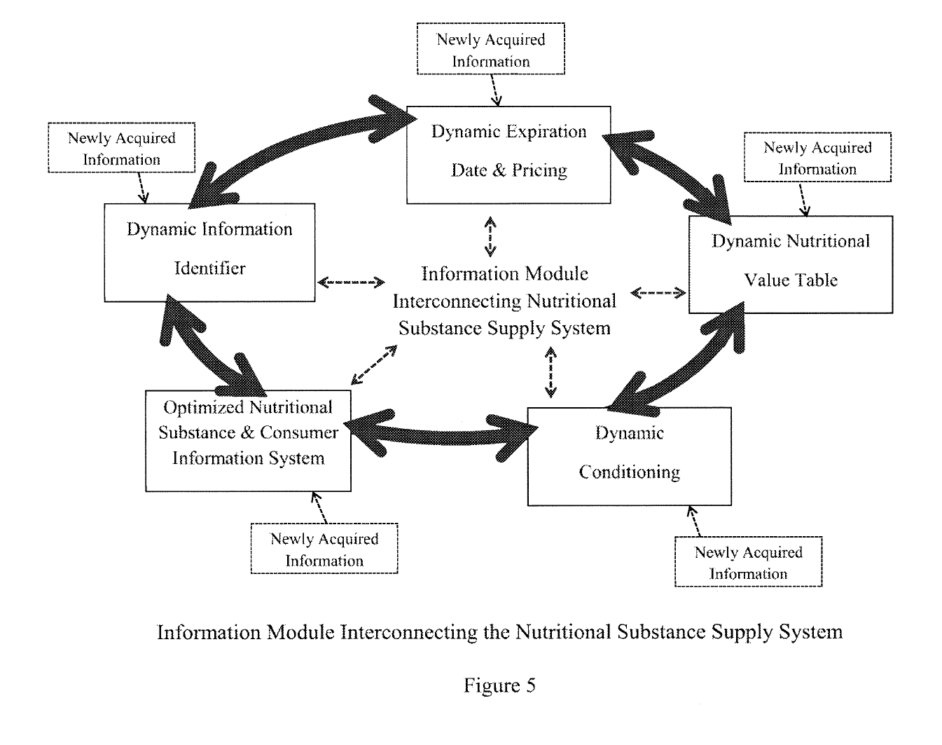

FIG. 5 shows how the information module of the present invention functions to facilitate collection, preservation, and distribution of various types of dynamic information about an information-enabled nutritional substance and a consumer of the information-enabled nutritional substance.

As indicated in FIG. 5 by “Dynamic Information Identifier”, a nutritional substance is provided with a dynamic information identifier. The dynamic information identifier is a reference associated with source, origin and ΔN information regarding the nutritional substance collected and preserved by an information module interconnecting the nutritional substance supply system, as indicated by “Information Module Interconnecting Nutritional Substance Supply System”.

As indicated in FIG. 5 by “Dynamic Expiration Date & Pricing”, the information module of the present invention, which tracks ΔN information for the information-enabled nutritional substance, facilities the determination of a dynamic expiration date and dynamic pricing for the information-enabled nutritional substance.

As indicated in FIG. 5 by “Dynamic Nutritional Value Table”, the information module of the present invention, which tracks ΔN information for the information-enabled nutritional substance, facilities the determination of a dynamic nutritional value table for the information-enabled nutritional substance.

As indicated in FIG. 5 by “Dynamic Conditioning”, the information module of the present invention, which tracks ΔN information for the information-enabled nutritional substance and can estimate ΔN associated with proposed conditioning parameters, facilities the determination of dynamic conditioning parameters which are responsive to the ΔN of the information-enabled nutritional substance prior to conditioning, the ΔN of the information-enabled nutritional substance resulting from conditioning, and further responsive to the consumer's preferences and needs.

As indicated in FIG. 5 by “Optimized Nutritional Substance & Consumer Information System”, the information module of the present invention, which tracks ΔN information for the information-enabled nutritional substance and can estimate ΔN associated with proposed conditioning parameters, facilities the collection of information related to the consumer and his preferences and needs in nutritional substances.

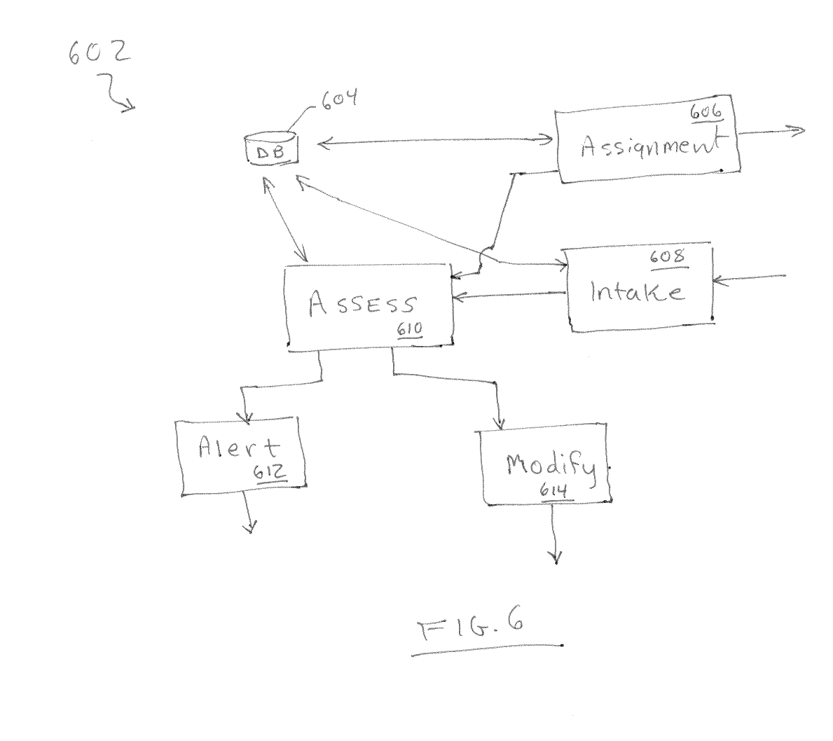

FIG. 6 is a block diagram of a system 602 for indicating the adulteration of a nutritional substance in accordance with certain embodiments. System 602 includes an assignment module 604 which assigns an identification code associated with a nutritional substance, so that it can be tracked as described herein. As explained above, upon creation, nutritional, organoleptic, and/or aesthetic value information relating to the nutritional substance is “appended” to the nutritional substance, either physically, by encoding, labeling, and the like, or relationally, such that a stored record of the nutritional substance that includes its unique identifier and other data also contains that information, unambiguously associated with the nutritional substance through the unique identifier for reference, recollection, assessment, manipulation, modification, updating, and so on. The record can be stored for instance in a data base 606. Assignment module 604 uniquely identifies the nutritional substance by assigning it a unique identifier, a record of which is stored in data base 606.

Also seen in FIG. 6 is intake module 608, operable to measure the initial nutritional, organoleptic, and/or aesthetic value information relating to the nutritional substance. This measured initial value is stored in data base 606 in association with the unique identifier of the nutritional substance.

An assessment module 610 determines the ΔN, that is, the change in nutritional, organoleptic, and/or aesthetic value information relating to the nutritional substance, using the initial measurement and a subsequent measurement taken by intake module 608. The assessment module consults the data base 604 in making its determination, reading the initial value stored therein in conjunction with the unique identifier, and the predetermined parameters associated with that particular nutritional substance. In certain embodiments, the assessment module 610 compares the determined change with an expected change associated with the nutritional substance and its identifier, in order to take into account some natural or predictable changes, such as normal degradation, oxidation, etc. or the course of time for the nutritional substance. The expected change can be stored in the data base 604, in a matrix of values that reflect changes over time, temperature, humidity, light exposure, and a host of other factors that can affect the evolution of the nutritional substance over time.

Alternatively, in certain embodiments, a surrogate sample of the nutritional substance is assessed. In particular, the nutritional substance can be initially prepared or packaged with a surrogate that is intended to mimic the expected natural behavior of an unadulterated or counterfeited version of the nutritional substance. The measurements that are taken by the intake module 608—initial or subsequent—can be measurements of characteristics of the surrogate and characteristics of the nutritional substance itself, and a comparison of the two is made to determine if the nutritional substance has progressed or degraded in the same manner as the surrogate. If so, then no adulteration or counterfeiting has taken place. If, on the other hand, the surrogate and the nutritional sample have degraded or evolved differently, then adulteration or counterfeiting will likely have occurred.

Finally, an alert module 612 issues an alert, if necessary, to indicate adulteration based on the output of the assessment module 610. Optionally, a modification module 614 can be provided, to modify the data base entry to reflect the ΔN and/or subsequent nutritional, organoleptic, and/or aesthetic value. Modification module 614 may also modify the “appended” labeling of the nutritional value to reflect the ΔN, alert condition, and so on.

While embodiments and applications have been shown and described, it would be apparent to those skilled in the art having the benefit of this disclosure that many more modifications than mentioned above are possible without departing from the inventive concepts disclosed herein.

1. A method for indicating the adulteration of a nutritional substance, comprising:
assigning to the nutritional substance a first nutritional value at a first one of multiple modules including a creation module, preservation module, transformation module, conditioning module and consumer module, the nutritional value corresponding to a characteristic of a component of the nutritional substance;
appending the first nutritional value as a record to the nutritional substance;
assigning to the nutritional substance a second nutritional value at a second one of the multiple modules;
appending the second nutritional value as a record to the nutritional substance;
determining a change, ΔN, between the first and second nutritional values;
performing a qualitative assessment of ΔN relative to one or more predetermined parameters; and
indicating whether the nutritional substance has been adulterated based on the qualitative assessment.

2. The method of claim 2, wherein the predetermined parameters are specific to the type of nutritional substance.

3. The method of claim 1, wherein the nutritional substance is meat.

4. The method of claim 1, wherein the predetermined parameters relate to the presence of horsemeat.

5. The method of claim 1, further comprising issuing an alert indicating that the nutritional substance has been adulterated.

6. The method of claim 1, wherein performing a qualitative assessment includes comparing the determined change with an expected change.

7. The method of claim 1, wherein performing a qualitative assessment includes comparing a measured sample from the nutritional substance with a measured sample from a surrogate of the nutritional substance.

8. A system for indicating the adulteration of a nutritional substance, comprising:
an assignment module operable to assign a unique identifier to a nutritional substance for storage in a data base;
an intake module operable to determine a first and a subsequent nutritional, organoleptic, and/or aesthetic value of the nutritional substance and to associate the first and subsequent values with the unique identifier in the data base;
an assessment module operable to determine a change, ΔN, between the first and subsequent determined values and to perform a qualitative assessment of ΔN relative to one or more predetermined parameters stored in the data base in association with the unique identifier; and
an alert module operable to issue an alert based on the qualitative assessment performed by the assessment module.

9. The system of claim 8, further comprising a modification module operable to alter an entry in the data base associated with the unique identifier to reflect ΔN or the subsequent nutritional, organoleptic, and/or aesthetic value, or both.

10. The system of claim 9, wherein the modification module is further operable to modify an appended value associated with the nutritional substance to reflect ΔN or the subsequent nutritional, organoleptic, and/or aesthetic value, or both.

11. The system of claim 8, wherein the predetermined parameters are specific to the type of nutritional substance.

12. The system of claim 8, wherein the nutritional substance is meat.

13. The system of claim 8, wherein the predetermined parameters relate to the presence of horsemeat.

14. The method of claim 8, wherein performing a qualitative assessment includes comparing the determined change with an expected change.

15. The method of claim 1, wherein performing a qualitative assessment includes comparing a measured sample from the nutritional substance with a measured sample from a surrogate of the nutritional substance.
